(19) United States
(12) Patent Application Publication
(10) Pub. No.: US 2025/0171674 A1
(43) Pub. Date: May 29, 2025

(54) LIGHT-ABSORBING HEAT-STORAGE COMPOSITE MATERIAL AND PREPARATION METHOD THEREOF

(71) Applicant: Shanxi Sanshui Energy Co., Ltd., Linfen (CN)

(72) Inventors: Junfa Zhang, Linfen (CN); Qinpei Wu, Linfen (CN); Ruimin Hao, Linfen (CN)

(21) Appl. No.: 18/807,817

(22) Filed: Aug. 16, 2024

(30) Foreign Application Priority Data
Nov. 23, 2023 (CN) 2023115705860

(51) Int. Cl. C09K 5/14

(52) U.S. Cl. CPC C09K 5/14

(57) ABSTRACT

A light-absorbing heat-storage composite material comprises a photo-thermal material and a heat-storage material. The heat-storage material comprises at least one of hydroxide, hydrate, molten salt, and organic phase change heat-storage material. The photo-thermal material comprises brown manganese ore silicate, and the photo-thermal material is used to enhance the absorbance and photo-thermal conversion rate of the heat-storage material, and complete the heat storage at the same time. The invention also provides a method for preparing the light-absorbing heat-storage composite material. The prepared photo-thermal composite material is a photo-thermal storage integrated material that can directly convert light energy into thermal energy and store heat, with small heat energy loss, high photo-thermal conversion efficiency, and cost saving.

### 1. TECHNICAL FIELD

The invention relates to the technical field of photo-thermal composite materials, and in particular to a light-absorbing heat-storage composite material and a preparation method thereof.

### 2. BACKGROUND ART

Solar energy is a huge green energy source. Huge amounts of solar radiation are projected onto the earth every day. Photo-thermal utilization is the main way to utilize solar energy, and photo-thermal power generation has been widely used. Photo-thermal conversion materials are the key to solar thermal utilization, and the performance of materials directly affects the efficiency of solar energy utilization. Excellent photo-thermal materials should have the advantages of high absorbance, ability to absorb sunlight at all wavelengths, high photo-thermal conversion efficiency, stable composition and structure, and low material cost. For household and industrial solar energy conversion materials, they should be able to work stably and for a long time at medium and high temperatures. Volatility and seasonality can affect the utilization of solar energy, and it can be solved with energy storage technology. Energy storage technology is the core support for the development of new energy and renewable energy. Compared with technologies such as electrochemical energy storage and electrical energy storage, thermal storage technology has significant advantages in terms of installed capacity, energy storage density, energy storage cost and service life. Compared with compressed air energy storage and pumped water energy storage, thermal storage technology has high energy storage density, small footprint, low cost, little impact on the environment, and is not restricted by geographical and environmental conditions.

However, traditional solar thermal storage technology uses pipes and heat transfer fluids to transfer heat energy. This process not only results in heat energy loss, but also increases equipment and maintenance costs. If the thermal storage material can directly convert light energy into heat energy and complete heat storage, the heat exchange and heat energy transfer process and related equipment can be eliminated, which has the advantage of practical application. In view of this, how to develop a light-absorbing heat-storage composite material that can absorb sunlight in the entire wave, has high photothermal conversion efficiency, stable performance, high temperature resistance and low cost, while reducing the number of equipment, shortening the photothermal storage process, and improving the efficiency of the photothermal storage system is a technical problem that needs to be solved urgently.

### 3. SUMMARY OF THE INVENTION

The purpose of the invention is to provide a light-absorbing heat-storage composite material with the functions of light-absorbing, heating and heat storage and a preparation method thereof. The photo-thermal material and the heat-storage material are combined to obtain a light-absorbing heat-storage composite material that solves the problem of low solar energy utilization efficiency caused by the inability of a single light-absorbing, heating material to store thermal energy. At the same time, it also solves the problems of large heat loss in the heat transfer process and low heat storage efficiency in the photo-thermal heat storage composite material in the prior art.

The invention is achieved by the following technical solutions.

A light-absorbing heat-storage composite material, comprising a photo-thermal material and a heat-storage material.

Further, the photo-thermal material comprises brown manganese ore silicate Mn_{7-x-y-z}MₓN_{y}P_{z}SiO₁₂.

Further, the light-absorbing heat-storage composite material comprises Mn_{7-x-y-z}MₓN_{y}P_{z}SiO₁₂-heat-storage material.

Further, the light-absorbing heat-storage composite material is a porous structure.

Further, the heat-storage material comprises one or more of hydroxide heat-storage materials, hydrate heat-storage materials, molten salt heat-storage materials, and organic phase change heat-storage materials.

Further, the hydroxide heat-storage material comprises one or more of magnesium hydroxide, aluminum hydroxide, lithium hydroxide, strontium hydroxide, boric acid, and calcium hydroxide.

Further, the hydrate heat-storage material comprises one or more of sodium sulfate hydrate, calcium sulfate hydrate, copper sulfate hydrate, magnesium sulfate hydrate, aluminum sulfate hydrate, aluminum potassium sulfate hydrate, sodium thiosulfate hydrate, sodium carbonate hydrate, calcium bromide hydrate, magnesium bromide hydrate, lithium chloride hydrate, lithium nitrate hydrate, zinc nitrate hydrate, iron nitrate hydrate, calcium nitrate hydrate, lanthanum nitrate hydrate, magnesium nitrate hydrate, strontium bromide hydrate, strontium chloride hydrate, calcium chloride hydrate, magnesium chloride hydrate, lanthanum chloride hydrate, lithium hydroxide hydrate, strontium hydroxide hydrate, sodium hydroxide hydrate, potassium hydroxide hydrate, magnesium chloride hydrate, iron chloride hydrate, aluminum chloride hydrate, sodium phosphate hydrate, and sodium hydrogen phosphate hydrate.

Further, the molten salt heat-storage material comprises one or more of sodium nitrate, potassium nitrate, calcium nitrate, lithium nitrate, sodium chloride, potassium chloride, and calcium chloride.

Further, the organic phase change heat-storage material comprises one or more of polyether, polyamide, and polyester.

Further, in the Mn_{7-x-y-z}MₓN_{y}P₂SiO₁₂, M, N, and P are selected from any three of the metal elements Ni, Co, Cu, Cr, V, Ti, Sr, Fe, Zn, Li, Ce, Bi, In, Sn, Mo, and W, and x, y, and z are selected from any numbers between 0 and 1 and can be arbitrarily combined, wherein y and z can be 0.

The invention also provides a preparation method of the light-absorbing heat-storage composite material, comprising the following steps:
(1) mixing water and ethanol in a volume ratio of 3:1 to obtain an ethanol solution, adding 7-x parts by mass of Mn(NO₃)₂, x parts by mass of metal element M, y parts by mass of metal element N, and z parts by mass of nitrate or chloride of metal element P, and stirring and dissolving to obtain a mixed solution A;
(2) adding 1 part by mass of Na₂SiO₃ to the mixed solution A obtained in step (1), and stirring and dissolving to obtain a mixed solution B;
(3) slowly adding amino acids to deionized water twice the volume of the ethanol solution in step (1), with the mass ratio of deionized water to amino acids being 20:1, and stirring until completely dissolved; then adding the heat-storage material, slowly stirring for 10-20 minutes, mixing with the mixed solution A in step (1), stirring for 8-15 minutes, and slowly dropping the mixed solution B obtained in step (2) to obtain a mixed solution C;
(4) still standing the mixed solution C obtained in step (3) for 3 hours, calcining at 500-600° C. for 5-6 hours, and cooling to room temperature; after washing with deionized water for 3 times, adding an equal volume of deionized water as the ethanol solution in step (1), hydrating at 110° C. for 1-2 hours, and drying at 120° C. for 4 hours to obtain a light-absorbing heat-storage composite material.

Further, in step (1), the mass ratio of Mn(NO₃)₂ and ethanol solution is 1:10.

Further, in step (3), the amount of heat-storage material added is 55-98% of the mass of the light-absorbing heat-storage composite material.

Compared with the prior art, the invention has the following advantageous effects.

The invention combines a photo-thermal material that can absorb light and generate heat with a heat-storage material to obtain a light-absorbing, heat-generating, and heat-storage composite material having the functions of absorbing light, generating heat and storing heat at the same time. The photo-thermal material is used to enhance the absorbance and photo-thermal conversion efficiency of the heat-storage material, and can directly absorb light energy and convert it into heat energy, and store the heat energy, completing the process of absorbing solar energy, photo-thermal conversion and heat storage in one step without the need for heat energy transmission, thus avoiding heat energy loss during heat energy transmission and equipment maintenance costs, and greatly simplifying the existing heat collection and heat storage systems. The light-absorbing heat-storage composite material prepared by the invention is a porous material that can absorb sunlight in full waves. At the same time, the formation of pores increases the heat and mass transfer channels. When irradiated with light, heat is conducted along the photo-thermal material and reflected in the pores, so the photo-thermal conversion efficiency and thermal conductivity are high. The heat-storage material of the invention can be selected from hydroxides, hydrates, molten salts, and organic phase change heat-storage materials. The photo-thermal material comprises brown manganese ore silicate Mn_{7-x-y-z}MₓN_{y}P_{z}SiO₁₂, and the material selection range is wide. At the same time, different photo-thermal materials and heat-storage materials can be mixed and used in multiple ways, and the temperature can be changed by changing the proportion of different metal elements in the photo-thermal materials, which can adapt to a variety of practical needs. Silicates have high melting points and stable chemical properties. Brown manganese compounds have good thermal conductivity and high hardness, which can avoid sintering problems. Due to the adsorption between photo-thermal materials and heat-storage materials, the photo-thermal materials are dispersed in the heat-storage materials. The heat energy generated through photo-thermal conversion can be directly stored in the heat-storage materials, which can significantly improve the utilization efficiency of solar thermal energy, reduce the loss of heat in the transfer process, and further reduce heat loss. The preparation method of the invention is simple and easy to control, low in cost, and easy to realize large-scale production; the prepared light-absorbing heat-storage composite material has the advantages of good light-absorbing and heating effect and strong heat storage capacity.

### 4. BRIEF DESCRIPTION OF THE DRAWINGS

In order to explain the embodiments of the invention or the technical solutions in the prior art more clearly, the drawings that need to be used in the description of the embodiments or the prior art will be introduced hereinafter. Obviously, the drawings in the following description are only some embodiments of the invention. For those of ordinary skill in the art, other drawings may be obtained from these drawings without creative efforts.

FIG. 1 is a SEM image of the light-absorbing heat-storage composite material according to Embodiment 1 of the invention;

FIG. 2 is a temperature spectrum of the light-absorbing heat-storage composite material according to Embodiment 1 and Embodiments 5-8 of the invention at different optical densities;

FIG. 3 is a graph showing the average absorptivity of the light-absorbing heat-storage composite material according to Embodiments 1-4 and Comparative Embodiments 1-4 of the invention to light at a wavelength of 250-2500 nm;

FIG. 4 is a graph showing the thermal conductivity of the light-absorbing heat-storage composite material according to Embodiments 1-4 and Comparative Embodiments 1-4 of the invention;

FIG. 5 is a graph showing the light-to-heat conversion efficiency of the light-absorbing heat-storage composite material according to Embodiments 1-4 and Comparative Embodiments 1-4 of the invention.

### 5. SPECIFIC EMBODIMENT OF THE INVENTION

In order to make the purpose, technical solutions and advantages of the invention more clearly understood, the invention is further described in detail hereinafter with reference to specific embodiments, but the invention is not limited to the following embodiments.

It should be noted that, unless otherwise specified, the chemical reagents involved in the invention were purchased through commercial channels.

Embodiment 1: the embodiment provides a preparation method of the light-absorbing heat-storage composite material Mn_{6.3}Cu_{0.7}SiO₁₂—Ca(OH)₂, comprising the following steps:
(1) mixing water and ethanol in a volume ratio of 3:1 to obtain an ethanol solution, adding 6.3 mmoL of Mn(NO₃)₂ and 0.7 mmoL of Cu(NO₃)₂, and stirring and dissolving to obtain a mixed solution A;
(2) adding 1 mmoL of Na₂SiO₃ to the mixed solution A obtained in step (1), and stirring and dissolving to obtain a mixed solution B;
(3) slowly adding amino acids to deionized water twice the volume of the ethanol solution in step (1), with the mass ratio of deionized water to amino acids being 20:1, and stirring until completely dissolved; then adding Ca(OH)₂, slowly stirring for 20 minutes, mixing with the mixed solution A in step (1), stirring for 15 minutes, and slowly dropping the mixed solution B obtained in step (2) to obtain a mixed solution C;
(4) still standing the mixed solution C obtained in step (3) for 3 hours, calcining at 600° C. for 6 hours, and cooling to room temperature; after washing with deionized water for 3 times, adding an equal volume of deionized water as the ethanol solution in step (1), hydrating at 110° C. for 2 hours, and drying at 120° C. for 4 hours to obtain a light-absorbing heat-storage composite material Mn_{6.3}Cu_{0.7}SiO₁₂—Ca(OH)₂.

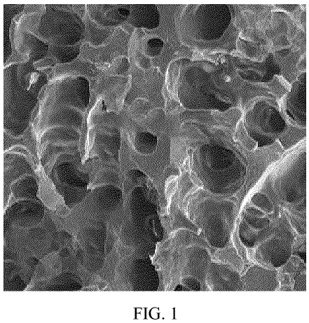

In step (1), the mass ratio of Mn(NO₃)₂ and ethanol solution is 1:10; in step (3), the amount of Ca(OH)₂ added is 98% of the mass of the light-absorbing heat-storage composite material Mn_{6.3}Cu_{0.7}SiO₁₂—Ca(OH)₂. As shown in FIG. 1, the SEM image shows that the obtained light-absorbing heat-storage composite material has a porous structure, which is beneficial to improving thermal conductivity and light-to-heat conversion efficiency.

Embodiment 2: the embodiment provides a preparation method of the light-absorbing heat-storage composite material Mn_{6.2}Sr_{0.3}Co_{0.5}SiO₁₂-calcium chloride hydrate, comprising the following steps:
(1) mixing water and ethanol in a volume ratio of 3:1 to obtain an ethanol solution, adding 6.2 mmol of Mn(NO₃)₂, 0.3 mmol of Sr(NO₃)₂, and 0.5 mmoL of Co(NO₃)₂, stirring and dissolving to obtain a mixed solution A;
(2) adding 1 mmoL of Na₂SiO₃ to the mixed solution A obtained in step (1), and stirring and dissolving to obtain a mixed solution B;
(3) slowly adding amino acids to deionized water twice the volume of the ethanol solution in step (1), with the mass ratio of deionized water to amino acids being 20:1, and stirring until completely dissolved; then adding calcium chloride hydrate, slowly stirring for 10 minutes, mixing with the mixed solution A in step (1), stirring for 8 minutes, and slowly dropping the mixed solution B obtained in step (2) to obtain a mixed solution C;
(4) still standing the mixed solution C obtained in step (3) for 3 hours, calcining at 500° C. for 5 hours, and cooling to room temperature; after washing with deionized water for 3 times, adding an equal volume of deionized water as the ethanol solution in step (1), hydrating at 110° C. for 1 hour, and drying at 120° C. for 4 hours to obtain a light-absorbing heat-storage composite material Mn_{6.2}Sr_{0.3}Co_{0.5}SiO₁₂-calcium chloride hydrate.

In step (1), the mass ratio of Mn(NO₃)₂ and ethanol solution is 1:10; in step (3), the amount of Ca(OH)₂ added is 55% of the mass of the light-absorbing heat-storage composite material Mn_{6.2}Sr_{0.3}Co_{0.5}SiO₁₂-calcium chloride hydrate.

Embodiment 3: the embodiment provides a preparation method of the light-absorbing heat-storage composite material Mn_{5.6}Fe_{0.3}Li_{0.7}Co_{0.4}SiO₁₂—KCl, comprising the following steps:
(1) mixing water and ethanol in a volume ratio of 3:1 to obtain an ethanol solution, adding 5.6 mmol of Mn(NO₃)₂, 0.3 mmol of FeCl₃, 0.7 mmoL of LiNO₃, and 0.4 mmol of Co(NO₃)₂, and stirring and dissolving to obtain a mixed solution A;
(2) adding 1 mmoL of Na₂SiO₃ to the mixed solution A obtained in step (1), and stirring and dissolving to obtain a mixed solution B;
(3) slowly adding amino acids to deionized water twice the volume of the ethanol solution in step (1), with the mass ratio of deionized water to amino acids being 20:1, and stirring until completely dissolved; then adding the heat-storage composite material, slowly stirring for 15 minutes, mixing with the mixed solution A in step (1), stirring for 12 minutes, and slowly dropping the mixed solution B obtained in step (2) to obtain a mixed solution C;
(4) still standing the mixed solution C obtained in step (3) for 3 hours, calcining at 500° C. for 5.5 hours, and cooling to room temperature; after washing with deionized water for 3 times, adding an equal volume of deionized water as the ethanol solution in step (1), hydrating at 110° C. for 1.5 hours, and drying at 120° C. for 4 hours to obtain a light-absorbing heat-storage composite material Mn_{5.6}Fe_{0.3}Li_{0.7}Co_{0.4}SiO₁₂—KCl.

In step (1), the mass ratio of Mn(NO₃)₂ and ethanol solution is 1:10; in step (3), the amount of Ca(OH)₂ added is 70% of the mass of the light-absorbing heat-storage composite material Mn_{5.6}Fe_{0.3}Li_{0.7}Co_{0.4}SiO₁₂—KCl.

Embodiment 4: the embodiment provides a preparation method of the light-absorbing heat-storage composite material Mn_{6.1}Cr_{0.3}Ce_{0.3}Ni_{0.3}SiO₁₂-polyamide, comprising the following steps:
(1) mixing water and ethanol in a volume ratio of 3:1 to obtain an ethanol solution, adding 6.1 mmol of Mn(NO₃)₂, 0.3 mmol of Cr(NO₃)₂, 0.3 mmol of Ce(NO₃)₃, and 0.3 mmol of Ni(NO₃)₂, and stirring and dissolving to obtain a mixed solution A;
(2) adding 1 mmoL of Na₂SiO₃ to the mixed solution A obtained in step (1), and stirring and dissolving to obtain a mixed solution B;
(3) slowly adding amino acids to deionized water twice the volume of the ethanol solution in step (1), with the mass ratio of deionized water to amino acids being 20:1, and stirring until completely dissolved; then adding the heat-storage composite material, slowly stirring for 15 minutes, mixing with the mixed solution A in step (1), stirring for 12 minutes, and slowly dropping the mixed solution B obtained in step (2) to obtain a mixed solution C;
(4) still standing the mixed solution C obtained in step (3) for 3 hours, calcining at 550° C. for 5.5 hours, and cooling to room temperature; after washing with deionized water for 3 times, adding an equal volume of deionized water as the ethanol solution in step (1), hydrating at 110° C. for 1.5 hours, and drying at 120° C. for 4 hours to obtain a light-absorbing heat-storage composite material Mn_{6.1}Cr_{0.3}Ce_{0.3}Ni_{0.3}SiO₁₂-polyamide.

In step (1), the mass ratio of Mn(NO₃)₂ and ethanol solution is 1:10; in step (3), the amount of Ca(OH)₂ added is 85% of the mass of the light-absorbing heat-storage composite material Mn_{6.1}Cr_{0.3}Ce_{0.3}Ni_{0.3}SiO₁₂-polyamide.

Embodiments 5-8 are the same as Embodiment 1, except that the amounts of added Mn(NO₃)₂ and Cu(NO₃)₂ are 6.6 mmoL: 0.4 mmol, 6.5 mmoL: 0.5 mmoL, 6.4 mmol: 0.6 mmoL, and 6.2 mmoL: 0.8 mmoL, respectively.

Comparative Embodiment 1 is the same as Embodiment 1, except that the proportion of calcium hydroxide is 10%.

Comparative Embodiment 2 is the same as Embodiment 1, except that still standing the mixed solution C obtained in step (3) for 3 hours, filtering, washing with deionized water for 3 times, and then adding an equal volume of deionized water as the ethanol solution in step (1), hydrating at 110° C. for 4 hours, and drying at 120° C. for 4 hours to obtain a light-absorbing heat-storage composite material Mn_{6.3}Cu_{0.7}SiO₁₂—Ca(OH)₂.

Comparative Embodiment 3 is the same as Embodiment 1, except that Mn(NO₃)₂ is replaced by NaNO₃.

Comparative Embodiment 4 is the same as Embodiment 1, except that Cu(NO₃)₂ is replaced by CaNO₃.

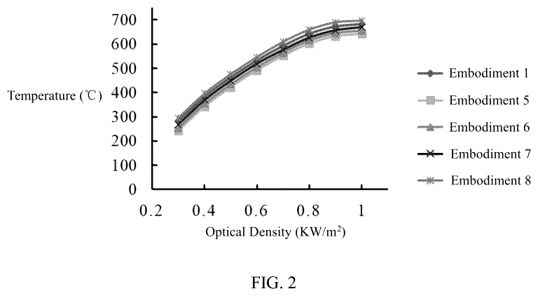

Experimental Embodiment 1: irradiating the light-absorbing heat-storage composite materials prepared in Embodiment 1 and Embodiments 5-8 at different light densities to obtain temperature maps, and the results are shown in FIG. 2. The photo-thermal temperature of the light-absorbing heat-storage composite material prepared in Embodiment 1 is 683° C., and the photo-thermal temperatures of Embodiments 5-8 are 642° C., 654° C., 669° C. and 696° C., respectively. The photo-thermal temperature increases with the increase of copper ion content, indicating that different photo-thermal temperatures can be achieved by changing the proportion of metal elements, which has broad practical application value.

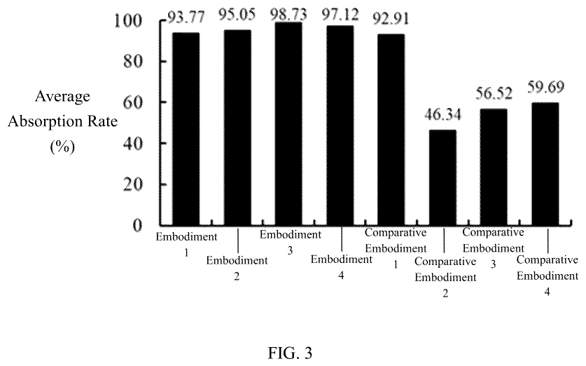

Experimental Embodiment 2: testing the absorbance of the light-absorbing heat-storage composite materials of Embodiments 1-4 and Comparative Embodiments 1-4 at a wavelength of 250-2500 nm with a UV-visible-near-infrared analyzer, and the results are shown in FIG. 3. At 250-2500 nm wavelength, the average absorptivity of Embodiments 1-4 and Comparative Embodiment 1 is above 90%, and the average absorptivity of Comparative Embodiments 2-4 is lower than 60%, indicating that high temperature causes micropores to be formed in the light-absorbing heat-storage composite material. The light absorption rate of the composite material can be improved. The brown manganese silicate prepared by the invention and the selected metal element type have a significant impact on the average absorption rate of the composite material.

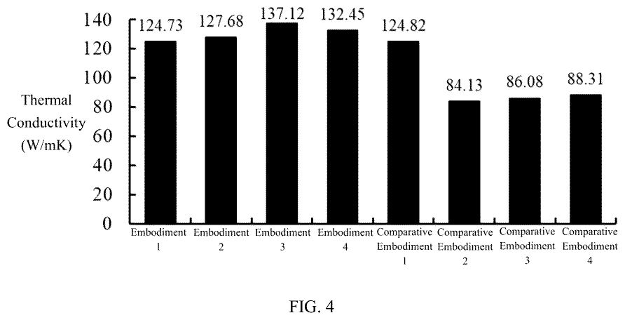

Experimental Embodiment 3: measuring the thermal conductivity of the light-absorbing heat-storage composite materials prepared in Embodiments 1-4 and Comparative Embodiments 1-4 with a laser thermal conductivity meter, and the results are shown in FIG. 4. The thermal conductivity of the composite materials prepared in Embodiments 1-4 and Comparative Embodiment 1 is much higher than that of Comparative Embodiments 2-3, indicating that the composite material of the invention has a higher thermal conductivity, the pores of the composite material can improve the thermal conductivity, and the obtained brown manganese ore silicate has high thermal conductivity.

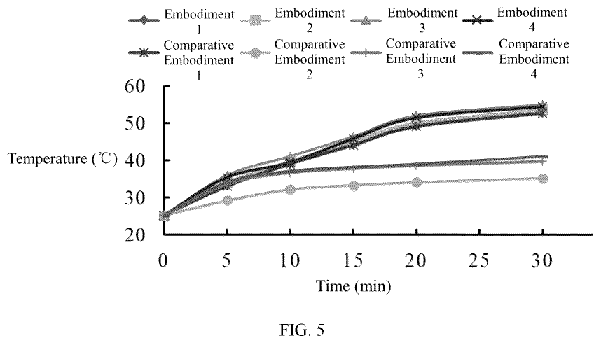

Experimental Embodiment 4: irradiating the light-absorbing heat-storage composite materials of Embodiments 1-4 and Comparative Embodiments 1-4 under a xenon lamp with a power of 50 W, recording the temperature change curve with the irradiation time, and the results are shown in FIG. 5. The results show that, after being irradiated under a xenon lamp for 30 minutes, the composite materials of Embodiments 1-4 and Comparative Embodiment 1 rose from the initial 25.3° C. to over 50° C., which was significantly higher than the 35.3-41.2° C. of Comparative Embodiments 2-3, indicating that the light-absorbing heat-storage composite material of the invention heats up quickly after absorbing sunlight, has a high efficiency in converting light energy into thermal energy, and has excellent photothermal conversion function.

Experimental Embodiment 5: taking the light-absorbing heat-storage composite materials of Embodiments 1-4 and Comparative Embodiments 1-4 and using a tablet press to compact them into a cylinder with a diameter of 1 cm and a height of 1 cm. The volume can be calculated to be 0.785 mL, weighing, calculating the density according to the formula density kg/L-mass/volume. Digging out 50 mg small pieces on each cylinder, and using a differential scanning calorimeter (DSC) to test the heat storage of the heat-storage material; then using the heat obtained from the test to convert to obtain the heat-storage density per unit volume of the composite material, and the results are shown in Table 1. The results show that the heat storage density of the composite material prepared in Embodiments 1-4 is significantly higher than that of Comparative Embodiments 1-4, indicating that the light-absorbing heat-storage composite material prepared by the invention has a high heat storage density and good heat storage effect.

TABLE 1
Heat Storage Density of Composite Materials

| | | Heat Storage | |
|---|---|---|---|
| | Density | Capacity of 50 mg | Heat Storage Density |
| | (kg/L) | (mJ) | (kJ/L) |
| Embodiment 1 | 1.34 | 59983 | 1607.5444 |
| Embodiment 2 | 1.25 | 59410 | 1485.25 |
| Embodiment 3 | 1.28 | 59677 | 1527.7312 |
| Embodiment 4 | 1.31 | 59821 | 1567.3102 |
| Comparative | 1.23 | 47346 | 1164.7116 |
| Embodiment 1 | | | |
| Comparative | 1.54 | 39613 | 1220.0804 |
| Embodiment 2 | | | |
| Comparative | 1.35 | 40096 | 1082.592 |
| Embodiment 3 | | | |
| Comparative | 1.33 | 40135 | 1067.591 |
| Embodiment 4 | | | |

Those skilled in the art should understand that the discussion of any of the above embodiments is merely illustrative and is not intended to imply that the scope of the invention (including the claims) is limited to these embodiments. Under the concept of the invention, the technical features in the above embodiments or different embodiments may be combined, the steps may be implemented in any order, and there are many other variations of the different aspects of the invention as described hereinabove, which are not provided in detail for the sake of simplicity.

The invention is intended to cover all such substitutions, modifications and variations that fall within the broad scope of the appended claims. Therefore, any omissions, modifications, equivalent substitutions, improvements, etc. made within the spirit and principles of the invention should be included in the scope of protection of the invention.

1. A light-absorbing heat-storage composite material, comprising a photo-thermal material and a heat-storage material.

2. The light-absorbing heat-storage composite material of claim 1, wherein the photo-thermal material comprises brown manganese ore silicate Mn_{7-x-y-z}MₓN_{y}P_{z}SiO₁₂.

3. The light-absorbing heat-storage composite material of claim 2, wherein the light-absorbing heat-storage composite material comprises Mn_{7-x-y-z}MₓN_{y}P_{z}SiO₁₂-heat-storage material.

4. The light-absorbing heat-storage composite material of claim 3, wherein the light-absorbing heat-storage composite material is a porous structure.

5. The light-absorbing heat-storage composite material of claim 4, wherein the heat-storage material comprises one or more of hydroxide heat-storage materials, hydrate heat-storage materials, molten salt heat-storage materials, and organic phase change heat-storage materials.

6. The light-absorbing heat-storage composite material of claim 5, wherein the hydroxide heat-storage material comprises one or more of magnesium hydroxide, aluminum hydroxide, lithium hydroxide, strontium hydroxide, boric acid, and calcium hydroxide; the hydrate heat-storage material comprises one or more of sodium sulfate hydrate, calcium sulfate hydrate, copper sulfate hydrate, magnesium sulfate hydrate, aluminum sulfate hydrate, aluminum potassium sulfate hydrate, sodium thiosulfate hydrate, sodium carbonate hydrate, calcium bromide hydrate, magnesium bromide hydrate, lithium chloride hydrate, lithium nitrate hydrate, zinc nitrate hydrate, iron nitrate hydrate, calcium nitrate hydrate, lanthanum nitrate hydrate, magnesium nitrate hydrate, strontium bromide hydrate, strontium chloride hydrate, calcium chloride hydrate, magnesium chloride hydrate, lanthanum chloride hydrate, lithium hydroxide hydrate, strontium hydroxide hydrate, sodium hydroxide hydrate, potassium hydroxide hydrate, magnesium chloride hydrate, iron chloride hydrate, aluminum chloride hydrate, sodium phosphate hydrate, and sodium hydrogen phosphate hydrate; the molten salt heat-storage material comprises one or more of sodium nitrate, potassium nitrate, calcium nitrate, lithium nitrate, sodium chloride, potassium chloride, and calcium chloride; the organic phase change heat-storage material comprises one or more of polyether, polyamide, and polyester.

7. The light-absorbing heat-storage composite material of claim 6, wherein in the Mn_{7-x-y-z}MₓN_{y}P_{z}SiO₁₂, M, N, and P are selected from any three of the metal elements Ni, Co, Cu, Cr, V, Ti, Sr, Fe, Zn, Li, Ce, Bi, In, Sn, Mo, and W, and x, y, and z are selected from any numbers between 0 and 1 and can be arbitrarily combined, wherein y and z can be 0.

8. A preparation method of the light-absorbing heat-storage composite material, comprising the following steps:
(1) mixing water and ethanol in a volume ratio of 3:1 to obtain an ethanol solution, adding 7-x parts by mass of Mn(NO₃)₂, x parts by mass of metal element M, y parts by mass of metal element N, and z parts by mass of nitrate or chloride of metal element P, and stirring and dissolving to obtain a mixed solution A;
(2) adding 1 part by mass of Na₂SiO₃ to the mixed solution A obtained in step (1), and stirring and dissolving to obtain a mixed solution B;
(3) slowly adding amino acids to deionized water twice the volume of the ethanol solution in step (1), with the mass ratio of deionized water to amino acids being 20:1, and stirring until completely dissolved; then adding the heat-storage material, slowly stirring for 10-20 minutes, mixing with the mixed solution A in step (1), stirring for 8-15 minutes, and slowly dropping the mixed solution B obtained in step (2) to obtain a mixed solution C;
(4) still standing the mixed solution C obtained in step (3) for 3 hours, calcining at 500-600° C. for 5-6 hours, and cooling to room temperature; after washing with deionized water for 3 times, adding an equal volume of deionized water as the ethanol solution in step (1), hydrating at 110° C. for 1-2 hours, and drying at 120° C. for 4 hours to obtain a light-absorbing heat-storage composite material.

9. The preparation method of the light-absorbing heat-storage composite material of claim 8, wherein in step (1), the mass ratio of Mn(NO₃)₂ and ethanol solution is 1:10.

10. The preparation method of the light-absorbing heat-storage composite material of claim 8, wherein in step (3), the amount of heat-storage material added is 55-98% of the mass of the light-absorbing heat-storage composite material.
